(19) United States
(12) Patent Application Publication
(10) Pub. No.: US 2019/0379638 A1
(43) Pub. Date: Dec. 12, 2019

(54) DEVICE FOR IMPLEMENTING UBIQUITOUS CONNECTIVITY AND PROTECTION SOFTWARE FOR IOT DEVICES

(71) Applicant: Vericlave, Inc., Dallas, TX (US)

(72) Inventors: Andrew Brian Arnberg, Montgomery, AL (US); Roy A. van Ermel Scherer, Lakeway, TX (US); John M. Medellin, Highland Village, TX (US)

(21) Appl. No.: 16/432,648

(22) Filed: Jun. 5, 2019

Related U.S. Application Data
(60) Provisional application No. 62/682,666, filed on Jun. 8, 2018.

(51) Int. Cl. H04L 29/06

(52) U.S. Cl. CPC H04L 63/0209

(57) ABSTRACT

A standalone security device comprises a first removable interface for connecting the standalone security device to a network. A second removable interface connects the standalone security device to at least one hardware device. The first removable interface and the second removable interface provide an electrical connection between the network and the at least one hardware device. A first reconfigurable microcontroller and a second reconfigurable microcontroller are electrically connected to each other between the first and second removable interfaces. A reconfigurable computer-on-module (COM) is electrically connected to the first reconfigurable microcontroller and the second reconfigurable microcontroller. The reconfigurable COM implements security protocols for communications between the network and the at least one hardware device. The second reconfigurable microcontroller is reconfigured based on a COM profile and provides one or more electrical signal flow paths between the COM and the first and second removable interfaces. The COM profile comprises at least one of a device configuration parameter or a device setting.

### CROSS-REFERENCE TO RELATED APPLICATIONS

This application claims the benefit of U.S. Provisional App. No. 62/682,666, filed on Jun. 8, 2018, entitled DEVICE FOR IMPLEMENTING UBIQUITOUS CONNECTIVITY AND PROTECTION SOFTWARE FOR IOT DEVICES (Atty. Dkt. No. NTGR60-34157) which is incorporated by reference in its entirety.

### TECHNICAL FIELD

The present invention relates to protection Internet of Things (IoT) edge devices from cyber-attacks, and more particularly to a stand-alone device configurable to implement different protection methods between a variety of compatible and non-compatible system architectures.

### BACKGROUND

All of the software protection schemes in existing technologies require a stable computer device to house their code. They rely on the hardware to translate the basic electrical messages in the communication protocol to messages that can be interpreted by the software. The typical computing platform for these infrastructures tend to be large in size, require large amounts of power and rely on interfacing to one or just some of the layer 2-3 protocols that exist today (e.g., TCP, TTY, ATM others). A device that is able to overcome these limitations and allow for connectivity and translation of layer 2 and layer 3 protocol to the higher layers so that protection software (such as attack surface minimization packages, firewalls and intrusion detection systems) can execute their mission would be greatly desirable.

### SUMMARY

The present invention, as disclosed and described herein, in one aspect thereof, comprises a standalone security device including a first removable interface for connecting the standalone security device to a network. A second removable interface connects the standalone security device to at least one hardware device. The first removable interface and the second removable interface provide an electrical connection between the network and the at least one hardware device. A first reconfigurable microcontroller and a second reconfigurable microcontroller are electrically connected to each other between the first and second removable interfaces. A reconfigurable computer-on-module (COM) is electrically connected to the first reconfigurable microcontroller and the second reconfigurable microcontroller. The reconfigurable COM implements security protocols for communications between the network and the at least one hardware device. The second reconfigurable microcontroller is reconfigured based on a COM profile and provides one or more electrical signal flow paths between the COM and the first and second removable interfaces. The COM profile comprises at least one of a device configuration parameter or a device setting.

### BRIEF DESCRIPTION OF THE DRAWINGS

For a more complete understanding, reference is now made to the following description taken in conjunction with the accompanying Drawings in which:

FIG. 1 illustrates a block diagram of a reconfigurable modular computing device (RCMD) for interconnecting components;

FIG. 2 illustrates a schematic diagram of an embodiment of a configurable computing device;

FIG. 3 illustrates a partial block diagram of embodiment of a configurable computing device;

FIG. 4 illustrates a block diagram of an embodiment of a configurable computing device;

FIG. 5 illustrates an architecture integration diagram of the RMCD;

FIG. 6 illustrates the modular software architecture which enables substitution of components in the RMCD;

FIG. 7 illustrates the International Standards Organization—Open Systems Interconnection (OSI) and the Institute of Electrical and Electronic Engineers standard Physical and Data link layer integration;

FIG. 8 illustrates the OSI model and associated layers of the TCP/IP protocol;

FIG. 9 illustrates the various capabilities of the RMCD;

FIG. 10a illustrates the hardware architecture of the RMCD;

FIG. 10b illustrates a wiring diagram for the self-contained architecture for the standalone RMCD;

FIG. 11 illustrates a housing of an RMCD device;

FIG. 12 illustrates a removable connector of an RMCD device;

FIG. 13 illustrates a perspective view of an RMCD device;

FIG. 14 illustrates the use of RMCD devices as shown in FIG. 13 within an industrial control network; and

FIG. 15 illustrates a flowchart of an embodiment of a computing device configuring method.

### DETAILED DESCRIPTION

Referring now to the drawings, wherein like reference numbers are used herein to designate like elements throughout, the various views and embodiments of device for implementing ubiquitous connectivity and protection software for IoT devices are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

The reconfigurable modular remote link inline computing device (RCMD) allows for interchangeability of computer components by using jack adapters as connectors instead of soldered wires to attach them as described in U.S. Pat. No. 8,751,710, entitled RECONFIGURABLE MODULAR COMPUTING DEVICE, filed Mar. 11, 2013, which is incorporated herein by reference in its entirety. The RCMD unit also provides for special purpose software to interpret the messages from one component into the format required by another component without having to add additional circuitry to enable communications between the components. This IoT implementation of the RCMD works well for mobile personal computer tablets. A drawback to the current RCMD implementation is that it needs to operate attached to a tablet computer and cannot operate as a stand-alone device. The requirement to be attached to a tablet computer requires that a tablet computer be purchased to house the RCMD.

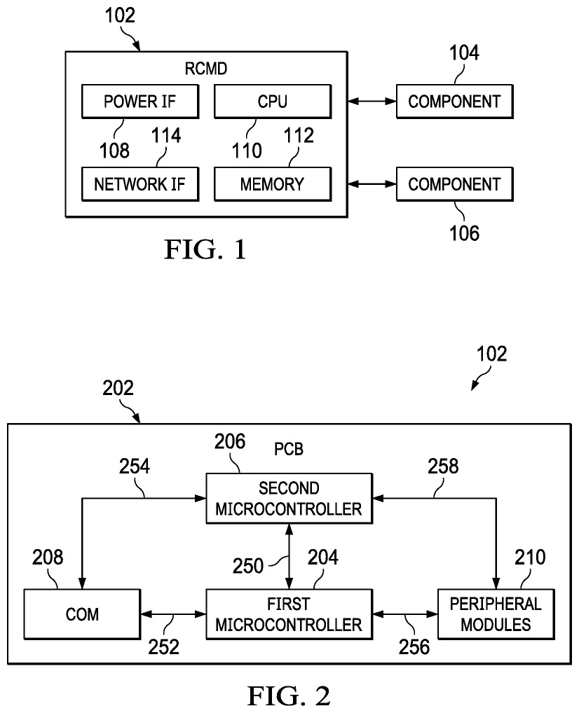

Referring now to FIG. 1, the standalone RCMD 102 translates the basic electrical messages in the communication protocol to messages that can be interpreted by the software transmitting messages between a first component 104 and a second component 106. The standalone RCMD 102 allows for connectivity and translation of layer 2 and layer 3 protocols to the higher layers so that protection software (such as attack surface minimization packages, firewalls and intrusion detection systems) can execute their mission. By placing the standalone RCMD 102 at these lower protocol layers it can protect unprotected application protocols such as Modbus or DNP3. The standalone RCMD 102 delivers a special purpose computer architecture that can work in all protocols of the ISO OSI model and deliver messages to the software so that the algorithms can analyze them. The current devices that deliver this functionality are multi-purpose and can be used for other tasks besides the execution of security software. They provide tasks such as data analysis and retrieval, and heavy computation. The current art is multi-purpose in the meaning expressed above and dedicates resources to other tasks. The standalone RCMD 102 is dedicated only to execution of security software and is more efficient because the standalone RCMD 102 does not need to dedicate resources to anything but execution of the security software.

The standalone RCMD 102 does not require attachment to a tablet and is able to provide for its own power via power interface 108, CPU 110, volatile and non-volatile storage 112 (RAM and secondary storage) and configurable network interfaces 114 (cards and jacks). The CPU 110 implements a dedicated security solution and is not required to support any other functionality. Thus, the RCMD 102 can comprise a standalone device for providing the security functionalities and supporting a ubiquitous implementation. This allows the standalone RCMD 102 to overcome the requirement to have to purchase a tablet to be able to operate the RCMD. The functionality can now be delivered by the RCMD 102 without being attached to a tablet. The RCMD 102 is capable of storing the security software and loading into its own main memory through volatile and non-volatile storage 112 that is housed within the RCMD 102. The RCMD 102 does not need to use a tablet's random access memory (RAM) or the disk in the tablet. In addition, the RCMD 102 has its own CPU 110 which allows it to operate on the instructions directed by the software which is resident in its volatile memory 112. This standalone device, delivered in a modular architecture can provide the same functionality that the one attached to the tablet can except that it is independent of a tablet and only needs to be connected to a power source (AC, Power over Internet, USB attachment to another computer for example) via power interface 108.

Because of the modular architecture, the standalone RCMD 102 configuration can be varied to fit the computing requirements of the various security software products that can be loaded into it. In some cases, based on user requirements, one software package might be selected which may not require as many resources (defined as storage, computing cycles per second, power requirements and main memory) and could execute the functions with less powerful components. In those cases, the CPU 110, storage 112, network interfaces 114 and power components 108 could be replaced for less powerful units and with less cost. These components do not have to be soldered, rather, they can be plugged in with the provided jacks and can be done in any location that has a person with the ability to read a diagram and plug the right socket into the right jack.

The ability to do upgrade or downgrade of device components in a non-laboratory environment also has the advantage of saving on higher skilled resources (they do not have to be skilled in micro-component analysis and soldering), time (because the unit does not have to be shipped to a controlled environment and back to the field) and facilities (because a laboratory “clean” environment for soldering does not need to be provided). This overall efficiency in engineering design reduces cycle-time (time to get the device ready for new requirements and deployment), resource cost (because the skill set required to change the components is lower than the one required to solder them) and expensive asset requirements (soldering tooling and a clean laboratory environment so that it can be protected from elements while being soldered).

Referring now to FIG. 2, there is illustrated a general block diagram of the RMCD 102 has two separate microcontrollers 204/206 that acts as message processors between the devices 104/106 and the CPU 110. It is configurable through software and avoids soldering of cable and pin placements through hardware that is removeably connected to a circuit board 202. Disclosed herein are embodiments of a standalone RMCD 102 and methods of using the same. In an embodiment, a RMCD 102 may be utilized to allow a user to configure and/or to reconfigure the RMCD for one or more applications, as needed, thereby providing the ability to configure the RMCD for a variety of applications. For example, the RMCD 102 may be configured for a first application (e.g., comprising a first set of functional units, peripheral connections, and user interfaces) and then may be reconfigured for a second application (e.g., comprising a second set of functional units, peripheral connections, and user interfaces), thereby providing the ability to adapt the RMCD for a given application.

The RMCD 102 may comprise a plurality of functional units. In an embodiment, a functional unit (e.g., an integrated circuit (IC)) may perform a single function, for example, serving as an amplifier or a buffer. Additionally or alternatively, the functional unit may perform multiple functions on a single chip. In an embodiment, the functional unit may comprise a group of components (e.g., transistors, resistors, capacitors, diodes, and/or inductors) on an IC which may perform a defined function. The functional unit may comprise a specific set of inputs, a specific set of outputs, and an interface (e.g., an electrical interface, a logic interface, and/or other interfaces) with other functional units of the IC and/or with external components. In some embodiments, the functional unit may comprise repeat instances of a single function (e.g., multiple flip-flops or adders on a single chip) or may comprise two or more different types of functional units which may together provide the functional unit with its overall functionality. For example, a microprocessor may comprise functional units such as an arithmetic logic unit (ALU), one or more floating-point units (FPU), one or more load or store units, one or more branch prediction units, one or more memory controllers, and other such modules. In some embodiments, the functional unit may be further subdivided into component functional units. For example, a microprocessor as a whole may be viewed as a functional unit of an IC, for example, if the microprocessor shares a circuit with at least one other functional unit (e.g., a cache memory unit).

The functional unit may comprise, for example, a general purpose processor, a mathematical processor, a state machine, a digital signal processor, a video processor, an audio processor, a logic unit, a logic element, a multiplexer, a demultiplexer, a switching unit, a switching element an input/output (I/O) element, a peripheral controller, a bus, a bus controller, a register, a combinatorial logic element, a storage unit, a programmable logic device, a memory unit, a neural network, a sensing circuit, a control circuit, a digital to analog converter (DAC), an analog to digital converter (ADC), an oscillator, a memory, a filter, an amplifier, a mixer, a modulator, a demodulator, and/or any other suitable devices as would be appreciated by one of ordinary skill in the art.

Referring to the embodiment of FIG. 2, a RMCD 102 may comprise a plurality of distributed components and/or functional units such that each functional unit may communicate with another functional unit via a suitable signal conduit, for example, via one or more electrical connections, as will be disclosed herein. For example, the RMCD 102 may generally comprise a printed circuit board (PCB) 202, a first microcontroller 204, a second microcontroller 206, a computer-on-module (COM) or system-on-module (SOM) 208, and one or more embedded or peripheral modules 210.

In an embodiment, the PCB 202 may be configured to provide physical and electrical connectivity between one or more functional units, for example, between one or more microcontrollers, between one or more peripheral modules, between a microcontroller and one or more peripheral modules, etc. The PCB 202 may generally comprise a non-conductive substrate having a plurality of conductive flow paths, tracks, traces, or the like, and thereby provides a plurality of routes for electrical signal communication. In an embodiment, the PCB 202 may comprise a plurality of preconfigured electrical signal flow paths (e.g., one or more conductive electrical signal flow paths etched onto the PCB 202) and a plurality of configurable electrical signal flow paths (e.g., one or more electronically switchable electrical signal flow paths, for example, via one or more transistors, microprocessors, etc.), as will be disclosed herein.

In an embodiment, the first microcontroller 204 and/or the second microcontroller 206 may be a peripheral interface controller (PIC), a field programmable gate array (FPGA), or an embedded processor and may generally comprise an ALU, one or more data registers, an ADC, one or more memory devices, a plurality of input/output (I/O) ports, a matrix switch, one or more signal conditioners or adapters, any other suitable functional unit as would be appreciated by one of ordinary skill in the art upon viewing this disclosure, or combination thereof. The first microcontroller 204 and/or the second microcontroller 206 may be configured to selectively provide one or more electrical signal flow paths, for example, via one or more I/O ports. In an embodiment, the first microcontroller 204 and/or the second microcontroller 206 may be configured to communicate an electrical signal to a plurality of I/O ports (e.g., a controller area network (CAN) bus, an Inter-Integrated Circuit (I.sup.2C) bus, a Universal Serial Bus (USB), a low pin count (LPC) bus, a Universal Asychronous Receiver/Transmitter (UART) bus, a low voltage differential signaling (LVDS) bus, etc.) and to employ any suitable signaling protocol as would be appreciated by one of ordinary skill in the art upon viewing this disclosure. For example, the first microcontroller 204 and/or the second microcontroller 206 may comprise a memory device having instructions to allow and/or to disallow one or more electrical signal flow paths (e.g., via one or more I/O ports) in response to a data signal (e.g., a device profile), as will be disclosed herein.

In an embodiment, the first microcontroller 204 and the second microcontroller 206 each comprise an electronic circuit configured to perform logical and/or arithmetic operations. Additionally, the first microcontroller 204 and/or the second microcontroller 206 may further comprise a memory storage device (e.g., an electrically erasable programmable read-only memory (EEPROM), an erasable programmable read-only memory (EPROM), a read-only memory (ROM), etc.) having a system basic input/output system (BIOS), a board support package (BSP), an operating system, a look-up table, a firmware, a driver, data instructions, or the like programmed onto the first microcontroller 204 and/or the second microcontroller 206, for example, for the purpose of performing one or more operations (e.g., detecting hardware, configuring I/O ports, performing an authentication, performing a verification, etc.). For example, the first microcontroller 204 may comprise a memory having start-up instructions, such as, reading a temperature sensor, initializing general purpose input/output (GPIO) ports, and enabling power flow (e.g., to a COM, one or more peripheral devices, etc.).

Additionally, the first microcontroller 204 and the second microcontroller 206 are configured to control the flow of data through the RMCD 102 and/or to coordinate the activities of one or more functional units of the RMCD 102. For example, the first microcontroller 204 and/or the second microcontroller 206 may be in electrical signal communication with and/or configured to control signal communications (e.g., data transmission) between the first microcontroller 204, the second microcontroller 206, the COM 208, the peripheral modules 210, any other suitable functional units, or combinations thereof. In an embodiment, the second microcontroller 206 may comprise a memory having a plurality of predefined I/O port configurations for a particular device (e.g., a COM, a peripheral module, etc.) and, thereby allowing the second microcontroller 206 to configure, monitor, police, etc. electrical signal communication via the second microcontroller 206.

In the embodiment of FIG. 2, the first microcontroller 204 is in electrical signal communication with the second microcontroller 206 (e.g., via electrical connection 250), the COM 208 (e.g., via electrical connection 252), the peripheral modules 210 (e.g., via electrical connection 256). Additionally, the second microcontroller 206 is in electrical signal communication with the COM 208 (e.g., via electrical connection 254) and the peripheral modules 210 (e.g., via electrical connection 258). Further, the RMCD 102 (e.g., first microcontroller 204 and/or the second microcontroller 206) may comprise a power management system, for example, comprising one or more voltage regulators, power distribution networks, voltage level converters, voltage rectifiers, etc. Additionally, the RMCD 102 may be supplied with electrical power via a power source, for example, via an on-board battery, an alternating current (AC) power supply, a direct current (DC) power supply, etc. For example, the RMCD 102 may be supplied power via a 12 volt wall adapter power supply.

Additionally, the first microcontroller 204 and/or the second microcontroller 206 may be configured to be removably coupled to the PCB 202. In such an embodiment, the first microcontroller 204 and/or the second microcontroller 206 may each be added to or removed from the PCB 202, for example, for programming purposes, as needed. For example, the first microcontroller 204 and/or the second microcontroller 206 may be coupled to a carrier board or baseboard having a peripheral connection bus (e.g., a plug-and-play device, a PCB comprising a plurality of electrical pins or contacts, etc.) and may be configured to couple with the PCB 202 via mating the peripheral connection bus of the first microcontroller 204 and/or the second microcontroller 206 to a suitable peripheral connection bus receiver on the PCB 202. In an embodiment, the first microcontroller 204 is a PIC24 family microcontroller. Additionally, the second microcontroller 206 is a Texas Instruments MSP430 family microcontroller. Alternatively, the first microcontroller 204 and/or the second microcontroller 206 may be any other suitable microcontroller as would be appreciated by one of ordinary skill in the art upon viewing this disclosure.

In an embodiment, the COM 208 may be configured to be removably coupled to the PCB 202. For example, the COM 208 may be added to or removed from the PCB 202, for example, for the purpose of configuring or reconfiguring the RMCD 102 for a given application. For example, the COM 208 may comprise a carrier board or baseboard having a peripheral connection bus (e.g., a Qseven module, an ITX, a PC-104, a COM express module, a plug-and-play device, a custom PCB comprising a plurality of electrical pins or contacts, etc.) and may be configured to couple with the PCB 202 via mating the peripheral connection bus of the COM 208 to a suitable peripheral connection bus receiver on the PCB 202.

In an embodiment, the COM 208 may generally comprise a central processing unit (CPU) or system-on-chip (SOC) (e.g., Intel Atom series, Freescale series, Texas Instruments OMAP series, etc.), a hub controller, a power management module, a memory device (e.g., a random access memory (RAM), a read only memory (ROM), a flash memory, a cache, etc.), a plurality of I/O ports (e.g., a PCIe bus, a CAN bus, an I.sup.2C bus, a USB, a LPC bus, a UART bus, a LVDS bus, a DisplayPort, etc.), an audio processor, a video processor, a multi-band radio module, any other suitable functional unit, or combination thereof. The COM 208 may be configured to support and/or to execute one or more instruction sets, for example, an X86 instruction set (e.g., an x86 platform) or BIOS, an ARM instruction set (e.g., an ARM platform) or BSP, etc. Additionally, the COM 208 may be configured to support and/to execute one or more operating systems (OS), for example, a Windows-based OS, a Linux-based OS, an Android-based OS, or the like. In an embodiment, the COM 208 is an x86 platform CPU. In an alternative embodiment, the COM 208 is an ARM platform CPU. Additionally, in an embodiment, the COM 208 is integrated onto a Qseven module or board.

In an embodiment, the one or more peripheral modules 210 may be configured to be removably coupled to the PCB 202. For example, in an embodiment, the one or more peripheral modules 210 may be added to or removed from the PCB 202, for example, for the purpose of configuring or reconfiguring the RMCD 102 for a given application. For example, the peripheral modules 210 may each comprise a carrier board or baseboard having a peripheral connection bus (e.g., a plug-and-play device, a PCB comprising a plurality of electrical pins or contacts, etc.) and may be configured to couple with the PCB 202 via mating the peripheral connection bus of the peripheral module 210 to a suitable peripheral connection bus receiver on the PCB 202.

In an embodiment, the peripheral modules 210 may be generally configured to provide increased functionality to the RMCD 102. For example, the peripheral modules 210 may comprise a display module, for example, a liquid crystal display (LCD), a light emitting diode (LED) display, an organic light emitting diode (OLED) display, an active-matrix organic light emitting diode (AMOLED) display, a color super twisted nematic (CSTN) display, a thin film transistor (TFT) display, a thin film diode (TFD) display, and/or any other suitable type of display as would be appreciated by one of ordinary skill in the art upon viewing this disclosure. Additionally or alternatively, the peripheral modules 210 may comprise one or more user interfaces, for example, a capacitive touchscreen, a resistive touchscreen, an inductive digitizer, a key pad, a mouse pad, a track ball, one or more buttons, any other suitable human input devices as would be appreciated by one of ordinary skill in the art upon viewing this disclosure, or combinations thereof. Additionally or alternatively, the peripheral modules 210 may comprise one or more sensors or cameras, for example, a CMOS imager module, a barcode module, a near field card reader module, a magnetic card reader module, a radio frequency identification (RFID) module, a biometric sensor module, a light detector module, a camera flash module, a global position system (GPS) module, a bedside monitor module, an accelerometer module, a gyroscope module, and/or any other suitable type of sensor or camera module as would be appreciated by one of ordinary skill in the art upon viewing this disclosure. Additionally or alternatively, the peripheral modules 210 may comprise one or more audio modules, for example, a speaker or a microphone. Additionally or alternatively, the peripheral modules 210 may comprise one or more communications or connectivity modules, for example, an ethernet module, a WiFi module, a radio module, a cellular radio module, an antenna, a multi-band antenna, a Bluetooth module, an infrared module, near filed communications module (NFC), and/or any other suitable type of communications or connectivity module as would be appreciated by one of ordinary skill in the art upon viewing this disclosure. Additionally or alternatively, the peripheral modules 210 may comprise one or more I/O connection modules, for example, an HDMI module, a RS-223 module, a USB module, a DVI module, a VGA module, an S-video module, a docking port interface module, and/or any other suitable type of I/O connection module. Additionally or alternatively, the peripheral modules 210 may comprise a power supply module, for example, a battery pack module. Additionally or alternatively, the peripheral modules 210 may comprise one or more military or security modules, for example, a common access card (CAC) reader module, a secure radio modem module, a selective availability GPS module, an encryption/decryption module, a SAASM/TacLink expansion module (STEM), and/or any other suitable military module. For example, in an embodiment, the peripheral modules 210 may comprise a STEM module comprising a military microgram GPS receiver with an embedded antenna and a secure TacLink 3300 data modem. Additionally or alternatively, the peripheral modules 210 may comprise any other suitable type and/or configuration of peripheral modules as would be appreciated by one of ordinary skill in the art upon viewing this disclosure.

The one or more peripheral modules 210 may be configured to communicate with the first microcontroller 204 and/or the second microcontroller 206 via any suitable electrical signal protocol (e.g., a protocol defined by the Institute of Electrical and Electronics Engineers (IEEE)) as would be appreciated by one of ordinary skill in the art upon viewing this disclosure.

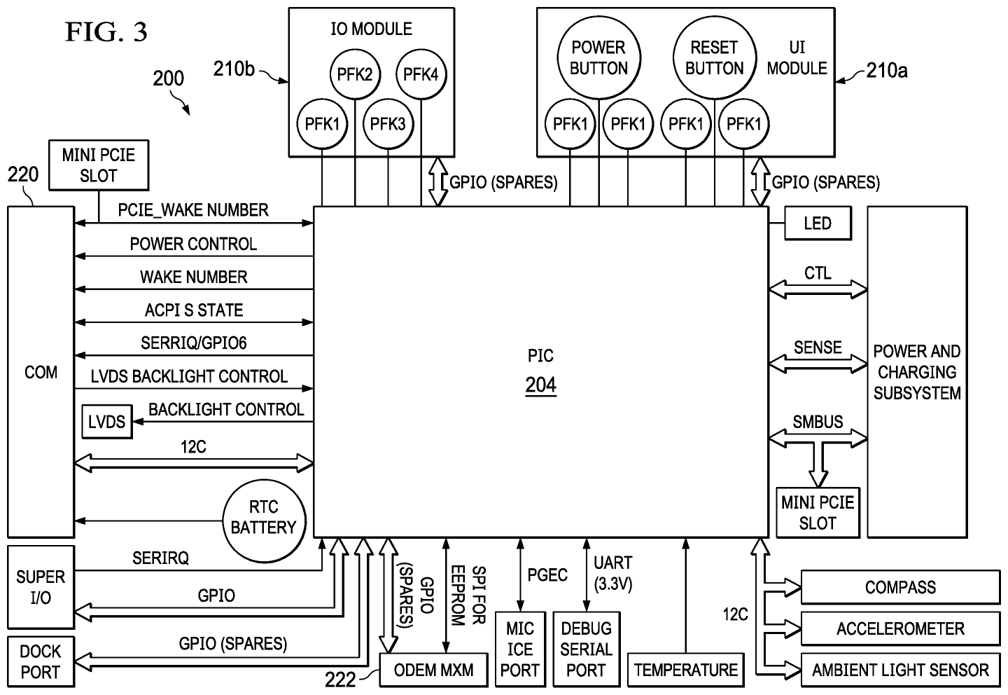

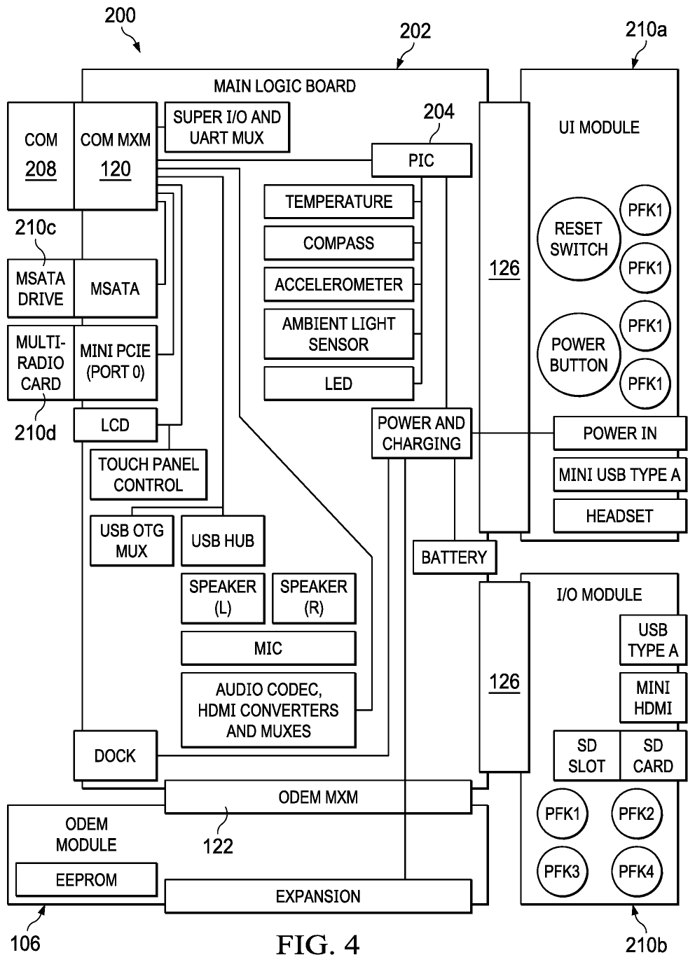

Referring to FIGS. 3-4, an embodiment of the RMCD 100 is illustrated. In such an embodiment, the first microcontroller 204 is a peripheral interface controller (PIC) and is integrated with the PCB 202 (e.g., shown as a main logic board (MLB)) and in electrical communication with a plurality of on-board devices and peripheral connections associated with the PCB 202 (e.g., sensors, I/O ports, etc.). For example, in the embodiment of FIG. 3, the first microcontroller 204 is in electrical signal communication with a plurality of connection buses (e.g., a COM connection bus 220, an on-demand expansion module (ODEM) connection bus 222, super I/O bus, etc.), sensors (e.g., compass, accelerometer, thermometer, etc.), I/O ports (e.g., a CAN bus, an I.sup.2C bus, a USB, a LPC bus, a UART bus, etc.), peripheral modules (e.g., user interface module 210a, I/O module 110b, etc.), and any other component or device associated with the PCB 202. Referring to FIG. 4, the second microcontroller 206, shown as ODEM module, is coupled to a carrier board having a peripheral connection bus (e.g., a plug-and-play device, a custom PCB comprising a plurality of electrical pins or contacts, etc.) and is coupled with the PCB 202 (e.g., MLB) via the peripheral connection bus receiver (e.g., the ODEM connection bus 222). The COM 208 may comprise a carrier board having a peripheral connection bus (e.g., a Qseven module, a plug-and-play device, a PCB comprising a plurality of electrical pins or contacts, etc.) and is coupled with the PCB 202 via the peripheral connection bus receiver (e.g., connection bus 220). Further, the PCB 202 is coupled to a plurality of peripheral modules. For example, the PCB 202 is coupled to a user interface (UI) module 210a having a plurality of buttons (e.g., a reset button, a power button, etc.) and I/O ports (e.g., a power terminal, a USB port, a headphone jack, etc.) via a connection bus 226, a I/O module 210b having a plurality of buttons and a I/O ports (e.g., a USB port, an HDMI port, a memory port, etc.), a radio module 210d (e.g., a multi-radio card), and a memory module 210c (e.g., a Mini-SATA).

Referring now back to FIG. 2, the PCB 202 may be provided comprising the first microcontroller 204 and the second microcontroller 206. Additionally, when providing the PCB 202 comprising the first microcontroller 204 and the second microcontroller 206, the first microcontroller 204 and/or the second microcontroller 206 may be programmed or reprogrammed with data and/or device setting configurations, for example, to provide a default device configuration and/or logical operations. For example, one or more I/O ports may be configured, a firmware may be installed, a driver may be installed, a BIOS may be configured, and/or any other suitable configuration operation may be performed as would be appreciated by one of ordinary skill in the art upon viewing this disclosure.

In an embodiment, a COM 208 may be provided and installed or coupled onto the PCB 202. For example, the COM 208 may be determined and/or configured for a desired application, for example, the COM 208 may comprise a preset operating system, CPU, chipset, etc. Where the COM 208 comprises a carrier board (e.g., a PCB have a plurality of electrical contacts), the COM 208 may be installed into a suitable receiver port (e.g., a peripheral connection bus) on the PCB 202, thereby providing a route of electrical signal communication between the COM 208 and the first microcontroller 204 and the COM 208 and the second microcontroller 206.

In an embodiment, following the coupling of the COM 208 to the PCB 202, the first microcontroller 204 and/or the second microcontroller 206 may interrogate the COM 208, for example, via the I/O ports (e.g., I.sup.2C, LPC, UART, etc.) and employing any suitable protocol and/or method as would be appreciated by one of ordinary skill in the art upon viewing this disclosure. For example, the first microcontroller 204 and/or the second microcontroller 206 may employ a hardware detection protocol (e.g., a plug-and-play protocol) to detect the presence of the COM 208, for example, via an OS, a firmware, a driver, or data instructions programmed onto the first microcontroller 204 and/or the second microcontroller 206. Additionally, upon detecting the presence of the COM 208, the first microcontroller 204 and/or the second microcontroller 206 may generate or determine a COM profile. The COM profile may generally comprise device information, device configuration parameters, and/or device settings, etc. based on the detected COM 208. For example, the COM profile may comprise CPU information (e.g., Intel Atom E780T, Freescale iMX6, etc.), chip set information, clock speed information, OS information, manufacturing information, security key encryption, or any other suitable information for distinguishing and/or describing a COM as would be appreciated by one of ordinary skill in the art upon viewing this disclosure.

In an embodiment, one or more peripheral modules 210 may be provided and installed or coupled onto the PCB 202. For example, the peripheral modules 210 may be determined and/or configured for a desired application. For example, the peripheral modules 210 may comprise one or more user interface modules (e.g., a display, a keypad, a touchscreen, etc.), one or more I/O modules (e.g., a HDMI module, a USB module, a VGA module, etc.), and/or any other suitable module as would be appreciated by one of ordinary skill in the art upon viewing this disclosure. The peripheral modules 210 may be installed into a suitable receiver port (e.g., a peripheral connection bus) on the PCB 202, thereby providing a route of electrical signal communication between the peripheral modules 210 and the first microcontroller 204 and the peripheral modules 210 and the second microcontroller 206.

In an embodiment, following the coupling of the peripheral modules 210 to the PCB 202, the first microcontroller 204 and/or the second microcontroller 206 may interrogate each of the peripheral modules 210. For example, the first microcontroller 204 and/or the second microcontroller 206 may employ a hardware detection protocol (e.g., a plug-and-play protocol) to detect the presence of each peripheral module 210, for example, via an OS, a firmware, a driver, or data instructions programmed onto the first microcontroller 204 and/or the second microcontroller 206. Additionally, upon detecting the presence of the peripheral modules 210, the first microcontroller 204 and/or the second microcontroller 206 may generate or determine a peripheral module profile. The peripheral module profile may generally comprise device information, device configuration parameters, and/or device settings, etc. based on the detected peripheral modules 210.

In an embodiment, the second microcontroller 206 may provide one or more electrical signal flow paths in response to the COM profile and/or the peripheral module profile. For example, one or more I/O ports of the second microcontroller 206 may be configured and/or reconfigured dependent on the COM 208 and/or the peripheral modules 210 coupled to the PCB 202 (e.g., based on the COM profile and/or the peripheral module profile), thereby allowing and/or disallowing one or more electrical signal flow paths between the COM 208 and the peripheral modules 210 via the second microcontroller 206.

In an embodiment, the second microcontroller 206 comprises a memory having a look-up table relating a plurality of predefined I/O port configurations with a particular device (e.g., a COM, a peripheral module, etc.). For example, following detecting a device coupled to the PCB 202, the second microcontroller 206 may determine the profile of the device (e.g., via the COM profile, the peripheral module profile, etc.) and may employ a predefined I/O port configuration associated with the detected device, thereby routing an electrical signal flow path and enabling electrical signal communication to the device via the second microcontroller 206. In an additional or alternative embodiment, the second microcontroller 206 may comprise and/or is coupled to a plurality of electronically switchable gates (e.g., a matrix switch, a gate array, etc.) and implement predefined switch configurations associated with the detected device, thereby routing an electrical signal flow path and enabling electrical signal communication to the device via the second microcontroller 206. Additionally, the second microcontroller 206 may determine (e.g., via the COM profile, the peripheral module profile, etc.) and allow the appropriate protocols and/or signaling to be performed based on the detected device. Alternatively, any suitable passive or active methods or techniques may be employed to configure the I/O ports of the second microcontroller 206 in response to a particular device, as would be appreciated by one of ordinary skill in the art upon viewing this disclosure.

In an embodiment, upon establishing one or more electrical signal flow paths via the second microcontroller 206, the COM 208 may communicate an electrical signal (e.g., a data signal) to/from the peripheral modules 210 via the electrical signal flow paths enabled by the second microcontroller 206. For example, the peripheral modules 210 may comprise a display (e.g., a LCD screen, a LED screen, etc.) and the COM 208 may display graphical data on the display. Additionally or alternatively, the peripheral modules 210 may comprise a plurality of I/O port modules (e.g., a USB module, an HDMI module, etc.) and the COM 208 may transfer data to/from the I/O port modules via the electrical signal flow paths enabled by the second microcontroller 206. Additionally or alternatively, the peripheral modules 210 may comprise a user interface module (e.g., a keypad, a touch screen, etc.) and the COM 208 may receive commands from a user via the user interface module via the electrical signal flow paths enabled by the second microcontroller 206. Additionally or alternatively, the peripheral modules 210 may comprise a sensor module (e.g., a camera, a RFID module, etc.) and the COM 208 may receiver sensor data from the sensor module via the electrical signal flow paths enabled by the second microcontroller 206. Additionally or alternatively, the peripheral modules 210 may comprise a communications module (e.g., a WiFi module, a cellular radio module, etc.) and the COM 208 may transmit and receive data via the communications module via the electrical signal flow paths enabled by the second microcontroller 206. Additionally or alternatively, the COM 208 may employ or communicate with any other suitable peripheral module 210 via the electrical signal flow paths enabled by the second microcontroller 206, as would be appreciated by one of ordinary skill in the art upon viewing this disclosure.

In an embodiment, the RMCD 102 may be reconfigured and the COM 208 may be replaced and/or removed from the PCB 202. For example, the COM 208 may be decoupled from the PCB 202, for example, via removing the COM 208 from a peripheral connection bus on the PCB 202. A second COM may be provided and installed onto or coupled to the PCB 202, for example, using the same connection and footprint as the COM 208. The second COM may be determined and/or configured (e.g., a preset operating system, CPU, chipset, etc.) for a desired application. In an embodiment, the second COM is different from the COM 208 (e.g., a change from a x86 COM platform to an ARM COM platform). In an alternative embodiment, the second COM is a new or updated version of the COM 208 (e.g., an x86 or ARM COM platform update, for example, an updated CPU, chip set, etc.).

The second COM may be installed into a suitable receiver port (e.g., a peripheral connection bus) on the PCB 202. The first microcontroller 204 and/or the second microcontroller 206 may interrogate the second COM to generate or determine a COM profile based on the second COM, similar to previously disclosed. Additionally, one or more I/O ports of the second microcontroller 206 may be configured and/or reconfigured dependent on the second COM coupled to the PCB 202 (e.g., based on the COM profile), thereby allowing and/or disallowing one or more electrical signal flow paths between the second COM and the peripheral modules 100 via the second microcontroller 206. Upon establishing one or more electrical signal flow paths via the second microcontroller 206, the second COM may communicate an electrical signal (e.g., a data signal) to/from the peripheral modules 210 via the electrical signal flow paths enabled by the second microcontroller 206.

In an embodiment, the RMCD 102 may be reconfigured and one or more peripheral modules may be replaced and/or removed from the PCB 202. For example, one or more peripheral modules (e.g., the UI module 210a and/or the I/O module 210b of FIG. 3) may be decoupled from the PCB 202, for example, via removing the peripheral module from a peripheral connection bus on the PCB 202. In an embodiment, one or more additional and/or different peripheral modules may be provided and installed or coupled onto the PCB 202. The peripheral modules may be determined and/or configured for a desired application. The first microcontroller 204 and/or the second microcontroller 206 may interrogate the peripheral modules to generate or determine a peripheral module profile based on the peripheral modules coupled to the PCB 202, similar to previously disclosed. Additionally, one or more I/O ports of the second microcontroller 206 may be configured and/or reconfigured dependent on the peripheral modules coupled to the PCB 202 (e.g., based on the peripheral module profile), thereby allowing and/or disallowing one or more electrical signal flow paths between the COM 208 and the peripheral modules via the second microcontroller 206. Upon establishing one or more electrical signal flow paths via the second microcontroller 206, the COM 208 may communicate an electrical signal (e.g., a data signal) to/from the peripheral modules via the electrical signal flow paths enabled by the second microcontroller 206.

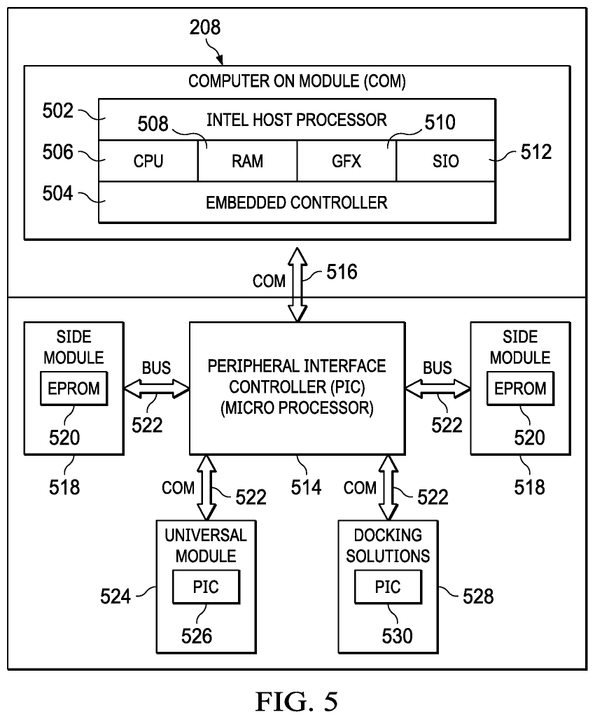

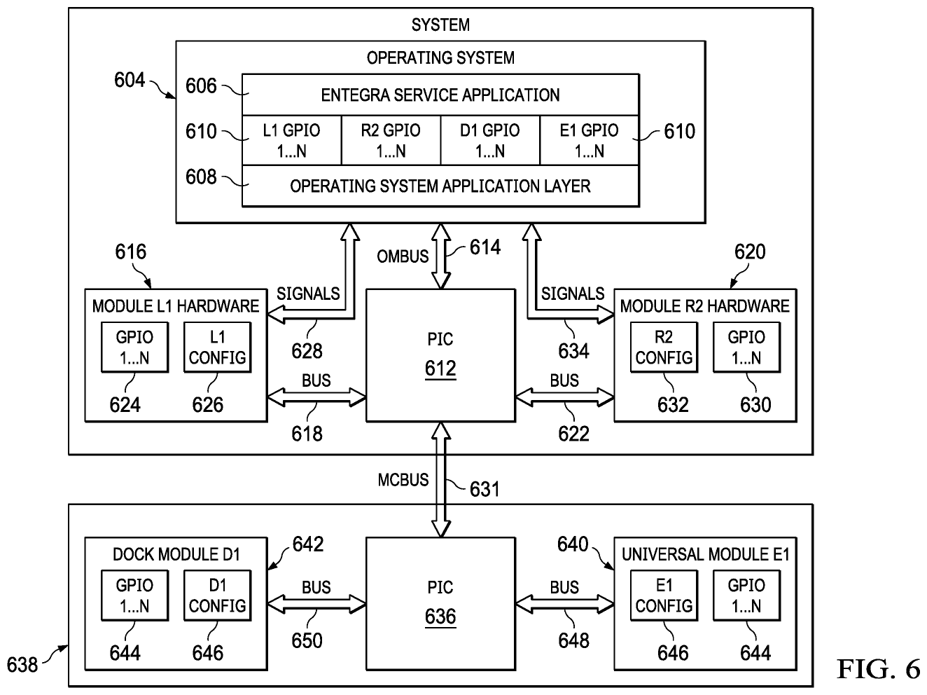

Referring now to FIG. 5, there is illustrated an architecture integration diagram of the RMCD 102. The diagram identifies of FIG. 5 the modularity of the various components in the existing RMCD 102 and the interface into the other components connected with the RMCD 102. The computer on module (COM) 208 includes a number of components for providing the systems operations. These include a host processor 502 which may in one embodiment comprise an Intel® processor. The COM 208 further includes an embedded controller 504 for controlling operations of the COM. Operations within the COM 208 are further assisted by a central processing unit (CPU) 506, random access memory (RAM) 508, graphics processing capabilities (GFX) 510 and serial input output interfaces (SIO) 512. The com 208 communicates with a peripheral interface controller (PIC) microprocessor 514 over a COM link 516. The PIC 514 interfaces the COM 208 with side modules 518 which may include EEPROM's 520 via bus links 522. The PIC 514 further provides com links 516 to a universal module 518 which may include a further peripheral interface controller 524 interconnections to a variety of other devices and docking solutions 528 also including a peripheral interface controller 530 for providing docking functionalities. FIG. 6 depicts the RMCD 102 with full functionality integrated into a single cased unit which is together in a detached architecture from a tablet.

Referring now to FIG. 6 there is depicted the modular software architecture which enables substitution of components in the standalone RMCD 102. The system software 602 includes operating system software 604. The operating system software 604 includes service application software 606 for providing various system applications and operating system application layer software 608 providing operation of the applications 606 through a number of general purpose input output (GPIO) software interfaces 610. The operating system software 604 communicates with the peripheral interface controller software 612 via the OMbus 614. The peripheral interface controller 612 communicates with module L1 hardware 616 via bus 618 and with module R2 hardware 620 via bus 622. The module L1 hardware 616 further includes general purpose input output (GPIO) software 624 and L1 configuration software 626. The module L1 hardware communicates with the operating system 604 over a communications link 628. The module R2 hardware 620 further includes general purpose input output (GPIO) software 630 and are to configuration software 632. The module R2 hardware communicates with the operating system 604 over a communications link 634.

The PIC 612 associated with the system software 602 communicates over MCBUS 631 with a peripheral interface controller 636 associated with various module software 638 these include the universal module E1 software 640 and dock module D1 software 642 over PIC bus 637. Each of the universal module E1 software 640 and dock module D1 software 642 includes GPIO software 644 and configuration software 646. The universal module software 640 and dock module software 642 communicate with the PIC 636 via bus links 648 and 650 respectively.

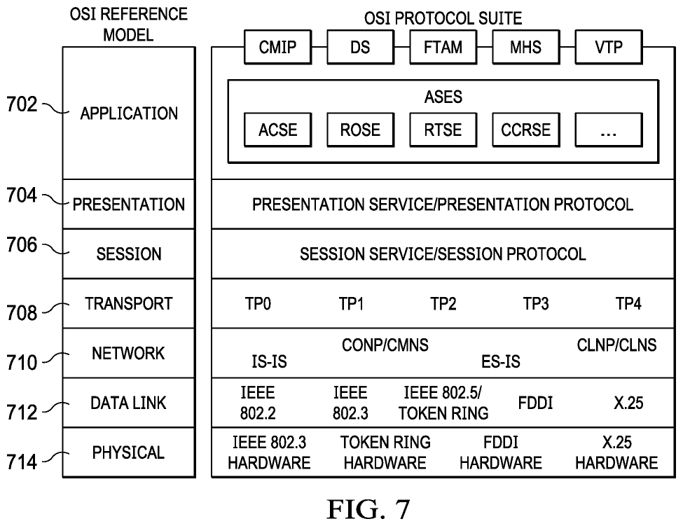

Referring now to FIG. 7, there is illustrated the International Standards Organization—Open Systems Interconnection (OSI) and the Institute of Electrical and Electronic Engineers standard 702 Physical and Data link layer integration. These layers are where the standalone RMCD 102 interconnects with the devices that are attached to the RMCD. The OSI reference model layers include the application layer 702 (layer 7), presentation layer 704 (layer 6), session layer 706 (layer 5), transport layer 708 (layer 4), network layer 710 (layer 3), data link layer 712 (layer 2) and physical layer 714 (layer 1). FIG. 7 also illustrates the various protocols associated with the OSI layers that are part of the OSI protocol suite. As can be seen, differing protocols are associated with differing OSI reference model layers.

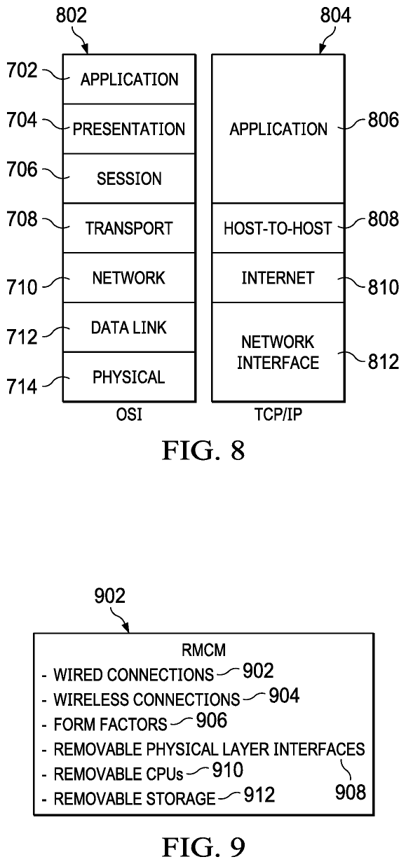

FIG. 8 illustrates the ISO-OSI model 802 and the corresponding layers of the Transmission Control Protocol/Internet Protocol 804. The network interface 812 in TCP/IP 804 corresponds to the first two layers of ISO-OSI (Data Link Layer 712 and Physical Layer 714). The Internet 810 in TCP/IP 804 is included in the network layer 710 of the ISO-OSI. The host to host 808 in TCP/IP 804 corresponds to the transport layer 708 of OSI 802. The applications 806 in TCP/IP 804 corresponds to the application 702, presentation 704 and session layer 706 of OSI 802.

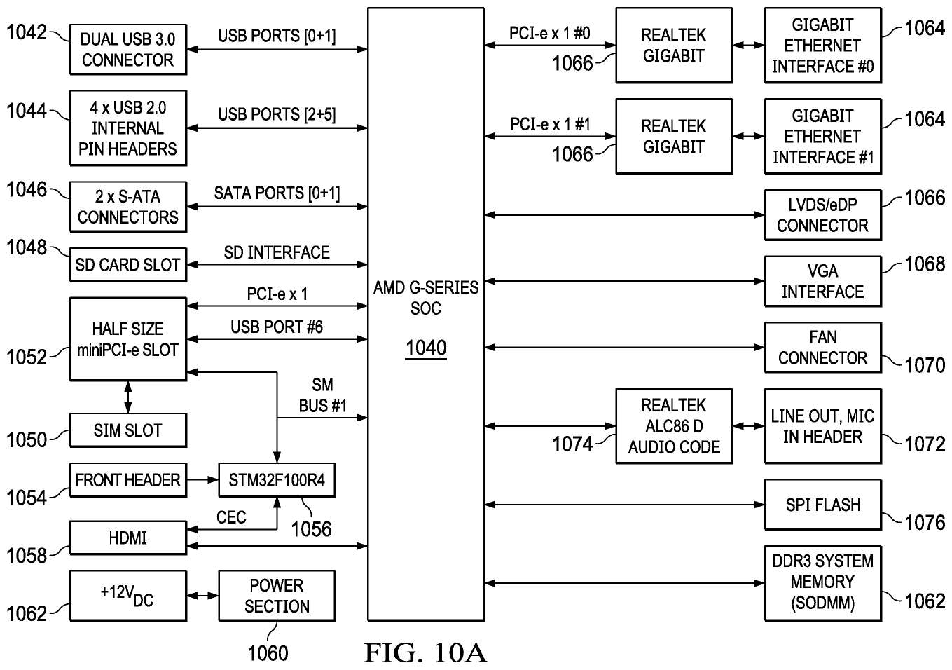

Referring now to FIG. 9, the standalone RMCD 102 has been further modified to reduce the physical size and make it standalone (versus attached to a personal tablet chassis) while continuing to support the software and socket driven modularity. The standalone RMCD 102 may be used to provide in-line (physically attached to wiring) connections 902 and WiFi (radio wave) connections 904 to a variety of network protocols as outlined in FIG. 7. Some of these protocols include TCP/IP, ATM, TTY and dial-up modems. The form factors 906 of the standalone RMCD 102 are ruggedized in order to operate in inclement climates of between 14 and 122 Fahrenheit (−10 to +50 C) and in physical drops of up to 3 feet.

The standalone RMCD 102 allows for changing the ISO-OSI physical layer interfaces using removable interfaces 908 by plugging new physical jacks that can enable connectivity to various network protocols without having to solder pins or provide for additional network control software. The current art requires that a specific device for connecting these networks be produced as a complete unit that only handles specific physical layer protocols. For example, a unit that is supposed to use 1 Gigabit Ethernet will require two Ethernet connectors, one on either side, and will be manufactured in mass quantities to provide this functionality. A separate unit having different connectors would be required and be mass produced as a totally separate unit to handle a different protocol (e.g., 9-pin serial communication for example).

The standalone RMCD 102 will deliver the ability to change removable interface 908 providing these jacks without having to change out the hardware or having to fabricate a new product. For example, if customer needs changed and a device that had been operating at 9-pin serial interface with a set of serial jacks needed to be changed to operate under a parallel Ethernet implementation, the interface 908 containing the old 9-pin serial interface jacks could be removed and new interfaces 908 containing the parallel Ethernet connetions placed in the standalone RMCD 102 without soldering, pin placement, changing of motherboard or reconfiguration of the firmware that controls the protocol. These functions are handled by the hardware and software of the standalone RMCD 102.

The standalone RMCD 102 also allows for changing of CPUs 110 based on customer needs. Just like the interface 908 to the physical layer devices can be changed, so can the CPU itself. The current embodiment of the standalone RMCD 102 uses an Intel x86 style processor. That particular processor could be substituted in the standalone RMCD for an ARM Cortex-9 style processor for example (replacing the three the CPU 110, Controller 1 204 and Controller 2 206) and running a separate messaging software interface (a set of program instructions that change the formats received into those required by the target device. The messaging software interface today resides in software on the components and interprets the outgoing device message format into the receiving message format that is required by the target device. In the previous art, this might be done with wires and soldering connections but now is provided as a software kit operating within the chips implemented in the standalone RMCD 102.

In a similar fashion, volatile and non-volatile memory 112 can be scaled up or down based on security software needs through jacks 912 instead of soldered wires and pins and the software messaging interface described above. This approach of changing storage components also carries the advantages of reduction in cost, efficiencies in human resources and reductions in time.

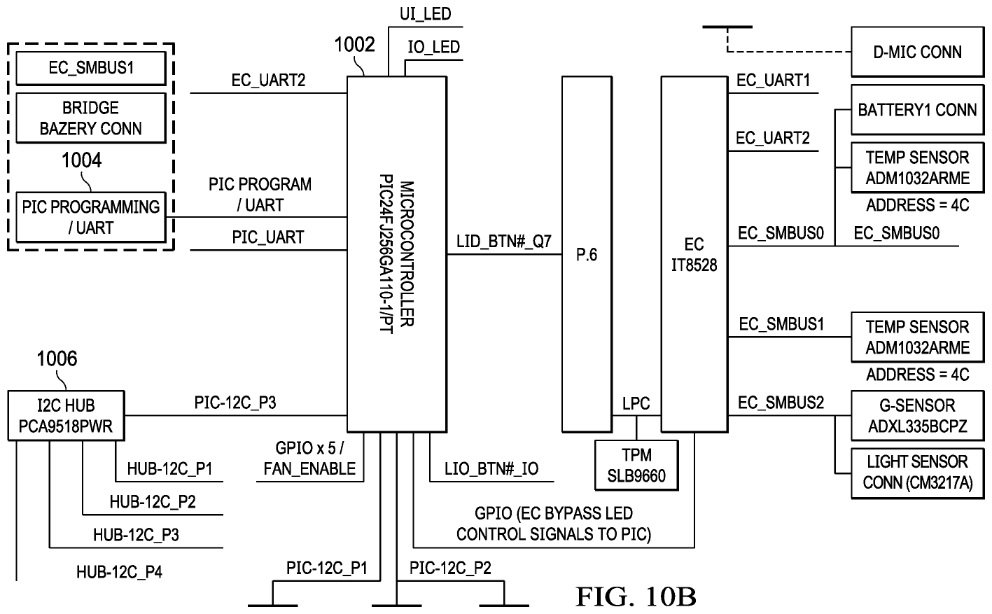

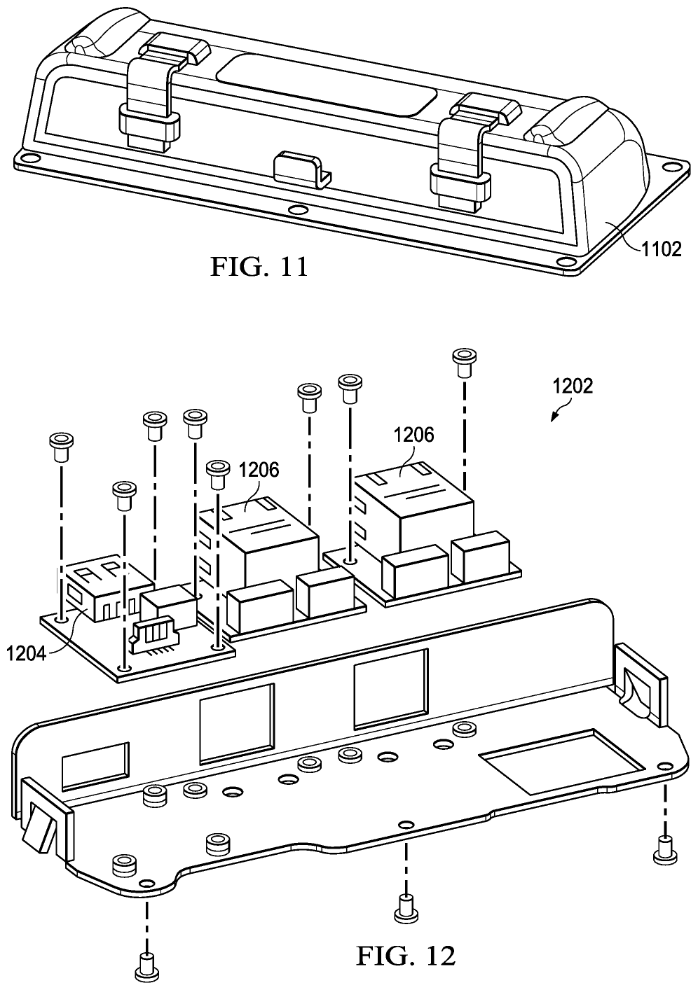

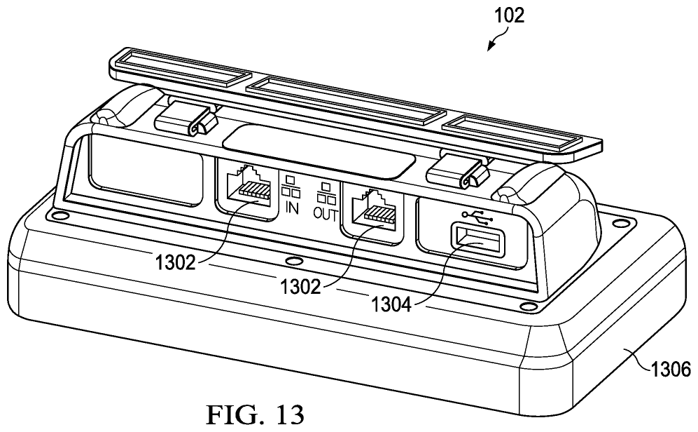

Referring now to FIG. 10a, there is illustrated the hardware architecture of the RMCD 102. The major components of the RCMP comprises a Seco SBC-992-plTX board, one USB daughter card, two ethernet daughter cards included within the housing described with respect to FIGS. 12 and 13. The central portion of the system comprises a processor 1040 comprising an AMD G-series SOC. Dual USB 3.0 connectors 1042 provide USB connections to the processor 1040 and four USB 2.0 internal pin headers 1044 provide further USB port connections. SATA ports are provided via two SATA connectors 1046. An SD card interface is provided to the processor 1040 through SD card slot 1048. Additional connections are provided to the processor 1040 through a SIM slot 1050 and half-size Mini PCI-e slot 1052. Front header connection 1054 to the processor 1040 through a microcontroller 1056 that in one embodiment may comprise an STM microelectronics STM32F100R4. Also included is an HDMI slot 1058. A power section 1060 provides power to the system through a 12 V DC connector 1062. The processor 1040 further connects to system memory 1062 that may in one embodiment comprise DDR3 system memory (SODIMM). A pair of gigabyte ethernet interfaces 1064 connect to the processor through gigabyte ethernet connections 1066. The processor 1040 may further provide connections to an LVDS/eDP connector 1066, a VGA interface 1068 and fan connector 1070. An audio line out, mic in header 1072 connects through an audio codec 1074 to processor 1040. An SPI flash 1076 also provides connection to the processor 1040.

Referring now to FIG. 10b, there is illustrated the wiring diagram for the self-contained architecture for the standalone RMCD 102. A microcontroller 1002 provides for control of the RMCD 102. The microcontroller 1002 connects with a PIC programming/UART device 1004 and I2C hub 1006. The interface jacks are removeably attached below the connection slots 1008 (PIC-12C_p1) and/or the connection slot 1010 (PIC-12C_p2) under the interface cards in the wiring diagram. The connection slots 1008/1010 provide connections to the microcontroller 1002.

Referring now to FIGS. 11 and 12, there are illustrated the external (casing) housing 1102 and the removable connectors 1202 for the standalone RMCD 102. FIG. 12 illustrates the removable connector 1202 comprising a USB port 1204 and parallel ethernet interface ports 1206. The removable connectors 1202 are connected to the printed circuit board of the RMCD 102 using some type of connector such a screws, nuts, latches, connection slots, ect. such that the connectors are electrically connected with the remainder of the components of the RMCD 102. The modularity of the system also supports different interfaces 1208 for connection to the RMCD 102 such as serial interfaces to support radio communications.

The RMCD 102 also provides for full Intel, MIPS or ARM style instruction set execution by the CPU 110. This means that the unit is able to execute versions of software that are compatible with the chip being deployed. The RMCD 102 is able to execute most of the commercially available security software (such as McAfee firewalls, BlueRidge Networks BorderGuard, EdgeGuard) if they run on a version of the chip-supported operating system (such as MSDOS, Windows, Linux or Unix). This will allow users to place a very high end, ruggedized, low-power, configurable processor within the RMCD 102 next to edge devices such as centrifuges or security cameras that may not be able to protect themselves but require high levels of software security protection. This will be particularly useful in such industries as Medicine, Industrial Controls/Supervisory Control And Data Acquisition (SCADA) and Retail establishments.

A further embodiment of the RMCD 102 is the implementation of the device with ethernet jacks supporting protection of a number of devices (e.g., centrifuge sensor controller in a power plant). The RMCD 102 (in this case) attaches to the Ethernet network cable. The device also has a McAfee firewall implemented that is resident and has been updated with a list of bad TCP/IP addresses who's messages should be ignored (e.g., a “black list”).

FIG. 13 provides an illustration of a perspective view of an RMCD 102. The device 102 includes Ethernet connectivity via a pair of Ethernet connectors 1302 and the ability to power through a USB port 1304 of the RMCD. A housing 1306 encloses the electronic components of the RMCD 102 and protects them from the elements.

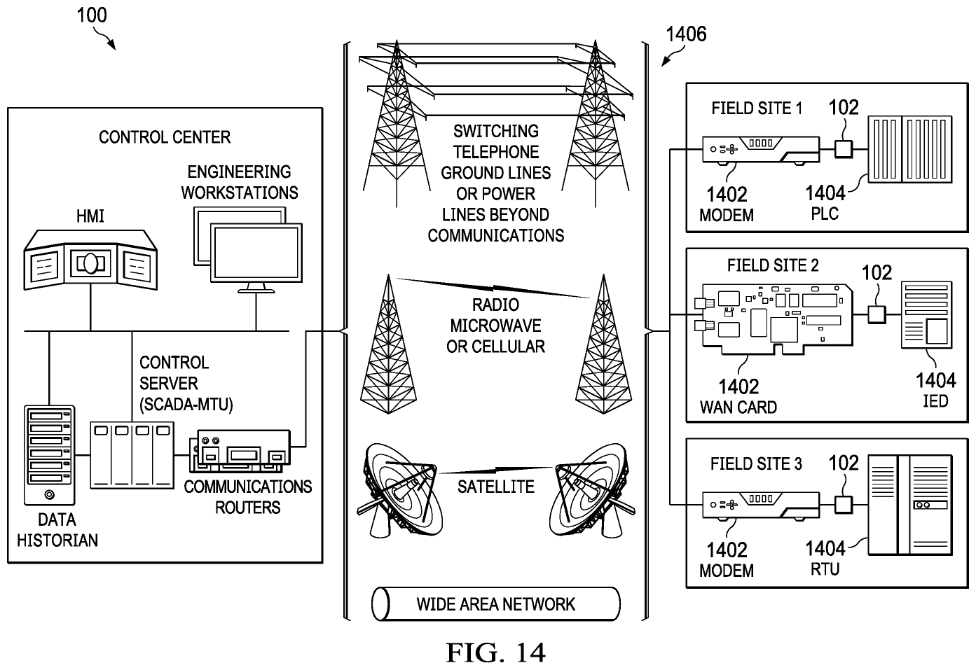

Referring now also to FIG. 14, there is illustrated the use of RMCD devices 102 within an industrial control network. Three of RMCD 102 devices are placed in FIG. 14 below. The incoming Ethernet wire connection from the Modem/WAN Card 1402 comes in to one of the Ethernet jacks of the RMCD 102 and the other Ethernet jack is an outgoing connection to the PLC/IED/RTU units 1404. In this way, the RMCD 102 is connected to the network 1406 and provides software security to the PLC/IED/RTU units 1404.

The device is placed next to the communication systems. The RMCD 102 is placed in front of the edge devices (PLC 1404a, IED 1404b, RTU 1404c) which are probably operating under different Layer 1 and 2 protocols. This means the devices require different interfaces and protocol management services. These different services and protocol management services are provided by the standalone RMCD 102.

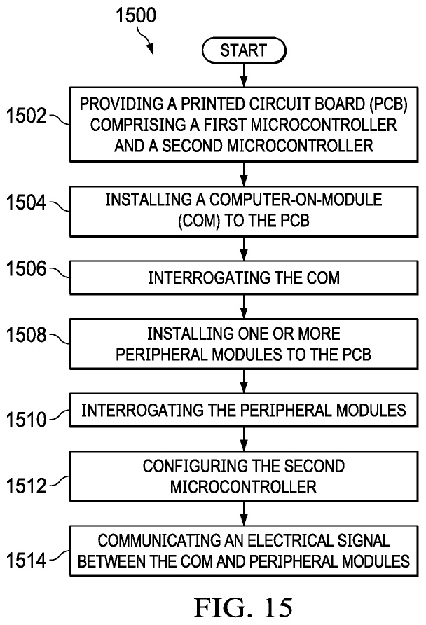

In an embodiment, a method of configuring a computing device utilizing a RMCD is disclosed herein. As illustrated in FIG. 15, a computing device configuring method 1500 may generally comprise the steps of providing a PCB (e.g., the MLB of FIG. 4) comprising a first microcontroller (e.g., the PIC of MLB of FIG. 4) and a second microcontroller (e.g., the ODEM module of FIG. 4) 1502, coupling a COM (e.g., the COM of FIG. 4) to the PCB 1504, interrogating the COM 1506, coupling one or more peripheral modules (e.g., UI module and I/O module of FIG. 4) to the PCB 1508, interrogating the peripheral modules 1510, configuring the second microcontroller 1512, and communicating an electrical signal between the COM and the peripheral modules via the second microcontroller 1514.

Optionally, the computing device configuring method 1500 may further comprise decoupling the COM from the PCB 202, coupling a second COM to the PCB 202, interrogating the second COM, configuring the second microcontroller 206, and communicating an electrical signal between the second COM and the peripheral modules 210. Additionally or alternative, the computing device configuring method 1500 may further comprise reconfiguring the peripheral modules 210, interrogating the peripheral modules 210, configuring the second microcontroller 206, and communicating an electrical signal between the COM and the peripheral modules 210.

It will be appreciated by those skilled in the art having the benefit of this disclosure that this device for implementing ubiquitous connectivity and protection software for IoT devices provides an improved method for providing software protection capabilities to edge network and IoT devices. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A standalone security device, comprising:
a first removable interface for connecting the standalone security device to a network;
a second removable interface for connecting the standalone security device to at least one hardware device, wherein the first removable interface and the second removable interface provides an electrical connection between the network and the at least one hardware device;
a first reconfigurable microcontroller and a second reconfigurable microcontroller electrically connected to each other between the first and second removable interfaces;
a reconfigurable computer-on-module (COM) electrically connected to the first reconfigurable microcontroller and the second reconfigurable microcontroller, wherein the reconfigurable COM implements security protocols for communications between the network and the at least one hardware device;
wherein the second reconfigurable microcontroller is reconfigured based on a COM profile and provides one or more electrical signal flow paths between the COM and the first and second removable interfaces; and
wherein the COM profile comprises at least one of a device configuration parameter or a device setting.

2. The standalone security device of claim 1, wherein the first removable interface and the second removable interface may be replaced with a new interface without soldering of the new interfaces.

3. The standalone security device of claim 1, wherein the first reconfigurable microcontroller and the second reconfigurable microcontroller may be replaced with a component without soldering of the new component.

4. The standalone security device of claim 1, wherein the first reconfigurable microcontroller and the second reconfigurable microcontroller may be replaced with processors having different processing capabilities and power requirements.

5. The standalone security device of claim 1, wherein the reconfigurable COM implements the security protocols for communications between the network and the at least one hardware device on OSI layers 1, 2 and 3 to protect components at these OSI layers and higher OSI layers that do not have a security protection scheme.

6. The standalone security device of claim 1, wherein the first removable interface has a first connector type and the second removable interface has a second connector type.

7. The standalone security device of claim 1, further comprising:
at least one peripheral module in electrical connection with the first microcontroller and in electrical connection with the COM via the second microcontroller;
wherein the second reconfigurable microcontroller is reconfigured based on the COM profile and a peripheral module profile and provides one or more electrical signal flow paths between the COM and at least one peripheral module; and
wherein the peripheral module profile comprises at least one of a device configuration parameter or a device setting.

8. A standalone security device, comprising:
a first removable interface for connecting the standalone security device to a network;
a second removable interface for connecting the standalone security device to at least one hardware device, wherein the first removable interface and the second removable interface provides an electrical connection between the network and the at least one hardware device;
a first reconfigurable microcontroller and a second reconfigurable microcontroller electrically connected to each other between the first and second removable interfaces;
a reconfigurable computer-on-module (COM) electrically connected to the first reconfigurable microcontroller and the second reconfigurable microcontroller, wherein the reconfigurable COM implements security protocols for communications between the network and the at least one hardware device;
at least one peripheral module in electrical connection with the first microcontroller and in electrical connection with the COM via the second microcontroller;
wherein the second reconfigurable microcontroller is reconfigured based on a COM profile comprising at least one of a device configuration parameter or a device setting and a peripheral module profile comprising at least one of a device configuration parameter or a device setting and provides one or more electrical signal flow paths between the COM and the at least one peripheral module.

9. The standalone security device of claim 8, wherein the first removable interface and the second removable interface may be replaced with a new interface without soldering of the new interfaces.

10. The standalone security device of claim 8, wherein the first reconfigurable microcontroller and the second reconfigurable microcontroller may be replaced with a component without soldering of the new component.

11. The standalone security device of claim 8, wherein the first reconfigurable microcontroller and the second reconfigurable microcontroller may be replaced with processors having different processing capabilities and power requirements.

12. The standalone security device of claim 8, wherein the reconfigurable COM implements the security protocols for communications between the network and the at least one hardware device on OSI layers 1, 2 and 3 to protect components at these OSI layers and higher OSI layers that do not have a security protection scheme.

13. The standalone security device of claim 8, wherein the first removable interface has a first connector type and the second removable interface has a second connector type.

14. A standalone security device, comprising:
a first removable interface for connecting the standalone security device to a network;
a second removable interface for connecting the standalone security device to at least one hardware device, wherein the first removable interface and the second removable interface provides an electrical connection between the network and the at least one hardware device;
a first reconfigurable microcontroller and a second reconfigurable microcontroller electrically connected to each other between the first and second removable interfaces;
a reconfigurable computer-on-module (COM) electrically connected to the first reconfigurable microcontroller and the second reconfigurable microcontroller, wherein the reconfigurable COM implements security protocols for communications between the network and the at least one hardware device on OSI layers 1, 2 and 3 to protect components at these OSI layers and higher OSI layers that do not have a security protection protocol;
at least one peripheral module in electrical connection with the first microcontroller and in electrical connection with the COM via the second microcontroller;
wherein the second reconfigurable microcontroller is reconfigured based on a COM profile comprising at least one of a device configuration parameter or a device setting and a peripheral module profile comprising at least one of a device configuration parameter or a device setting and provides one or more electrical signal flow paths between the COM and the at least one peripheral module.

15. The standalone security device of claim 14, wherein the first removable interface and the second removable interface may be replaced with a new interface without soldering of the new interfaces.

16. The standalone security device of claim 14, wherein the first reconfigurable microcontroller and the second reconfigurable microcontroller may be replaced with a component without soldering of the new component.

17. The standalone security device of claim 14, wherein the first reconfigurable microcontroller and the second reconfigurable microcontroller may be replaced with processors having different processing capabilities and power requirements.

18. The standalone security device of claim 14, wherein the first removable interface has a first connector type and the second removable interface has a second connector type.
